(19) United States
(12) Patent Application Publication
(10) Pub. No.: US 2024/0012692 A1
(43) Pub. Date: Jan. 11, 2024

(54) DYNAMIC LIGHT-WEIGHTED MULTI-TENANCY

(71) Applicant: International Business Machines Corporation, Armonk, NY (US)

(72) Inventors: Guangya Liu, Cary, NC (US); Xun Pan, Xian (CN); Peng Li, Xian (CN); Xiang Zhen Gan, Xian (CN); Hai Hui Wang, Xian (CN); Jin Song Wang, Beijing (CN)

(21) Appl. No.: 17/858,147

(22) Filed: Jul. 6, 2022

(51) Int. Cl. G06F 9/50

(52) U.S. Cl. CPC G06F 9/5072; G06F 9/5077; G06F 9/505

(57) ABSTRACT

A system may include a memory and a processor in communication with the memory. The processor may be configured to perform operations. The operations may include introducing a migration controller to an open-source container environment and assessing the open-source container environment for duplicative services. The operations may include selecting a shared service and a duplicated service from the duplicative services and redirecting resource requests through the migration controller to the shared service. The operations may include terminating the duplicated service.

### BACKGROUND

The present disclosure relates to distributed system workload management, and, more specifically, to user tenancy management in distributed systems.

Workload scheduling and workload distribution are common functions in the computer field, including in distributed systems. Distributed systems may include, for example, open-source container systems. Open-source containers offer adaptive load balancing, service registration, deployment, operation, resource scheduling, and capacity scaling. Centralized modules may be used for workload scheduling and distribution.

An open source container environment may host multiple tenants; for example, one super cluster may host seven tenants. Properly hosting multiple tenants in an open source container environment may require adaptations of the environment. Various mechanisms may be employed to manage hosting multiple tenants; for example, a super cluster may host multiple individual control planes (e.g., virtual clusters) each with independent resources (e.g., servers and controller managers) on a shared data plane. However, existing solutions for multi-tenancy in an open source container environment may suffer from decreased performance, security concerns, and/or give rise to administrative concerns.

### SUMMARY

Embodiments of the present disclosure include a system, method, and computer program product for dynamic light-weighted tenancy in a distributed workload environment.

A system may include a memory and a processor in communication with the memory. The processor may be configured to perform operations. The operations may include introducing a migration controller to an open-source container environment and assessing the open-source container environment for duplicative services. The operations may include selecting a shared service and a duplicated service from the duplicative services. The operations may include redirecting resource requests through the migration controller to the shared service and terminating the duplicated service.

In some embodiments of the present disclosure, the operations may include scaling the shared service to support the resource requests.

In some embodiments of the present disclosure, the operations may include calculating a duplicative resource usage of the open-source environment while the open-source environment uses the duplicative services. In some embodiments, the operations may include calculating a shared resource usage of the open-source environment while the open-source environment uses the shared service and assessing a resource savings between the duplicative resource usage and the shared resource usage. In some embodiments, the operations may further include engaging the redirecting resource requests because the resource savings achieves a savings threshold.

In some embodiments of the present disclosure, the operations may include enabling an end-user rule input.

In some embodiments of the present disclosure, the operations may include establishing a service combination ruleset for the duplicative services.

A computer-implemented method in accordance with the present disclosure may include introducing a migration controller to an open-source container environment and assessing the open-source container environment for duplicative services. The method may include selecting a shared service and a duplicated service from the duplicative services. The method may include redirecting resource requests through the migration controller to the shared service and terminating the duplicated service.

A computer program product in accordance with the present disclosure may include a computer readable storage medium having program instructions embodied therewith. The program instructions may be executable by a processor to cause the processor to perform a function. The function may include introducing a migration controller to an open-source container environment and assessing the open-source container environment for duplicative services. The function may include selecting a shared service and a duplicated service from the duplicative services. The function may include redirecting resource requests through the migration controller to the shared service and terminating the duplicated service.

The above summary is not intended to describe each illustrated embodiment or every implementation of the disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates the architecture of a system in accordance with some embodiments of the present disclosure.

FIG. 2 depicts the architecture of a system in accordance with some embodiments of the present disclosure.

FIG. 3 illustrates a service combination flowchart in accordance with some embodiments of the present disclosure.

FIG. 4 depicts a computer-implemented method in accordance with some embodiments of the present disclosure.

FIG. 5 illustrates computer-implemented method in accordance with some embodiments of the present disclosure.

FIG. 6 illustrates a cloud computing environment in accordance with embodiments of the present disclosure.

FIG. 7 depicts abstraction model layers in accordance with embodiments of the present disclosure.

FIG. 8 illustrates a high-level block diagram of an example computer system that may be used in implementing one or more of the methods, tools, and modules, and any related functions, described herein, in accordance with embodiments of the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to distributed system workload management, and, more specifically, to user tenancy management in distributed systems.

An open source container environment may host multiple tenants; various mechanisms may be employed to manage hosting multiple tenants.

In accordance with some embodiments of the present disclosure, an environment may share one service between multiple tenants, thereby reducing the need for duplication of service instances for each tenant that may use such an application. In accordance with some embodiments of the present disclosure, a migration controller may be used to implement dynamic light-weighted multi-tenancy.

In accordance with some embodiments of the present disclosure, a dynamic light weighted multi-tenancy mechanism may be used. The dynamic light weighted multi-tenancy mechanism may be used may be based on a virtual cluster model, which may also be referred to as a tenant cluster model; in a virtual cluster model, each tenant may have an independent, exclusive application programming interface (API) server, controller manager, and control plane (e.g., a key value store such as an etcd).

In accordance with some embodiments of the present disclosure, a dynamic light weighted multi-tenancy mechanism may use a migration controller to watch for any duplicated services that could be combined. Duplicated services for each tenant can be combined to reduce the footprint and the complexity of cluster via the migration controller. For example, for IAM services, one system may use one IAM and share it with different components; using a dynamic light weighted multi-tenancy mechanism, all of the IAM systems may be combined together to reduce the resource footprint and complexity of the platform.

In accordance with some embodiments of the present disclosure, a dynamic light weighted multi-tenancy mechanism may be used to dynamically combine duplicated services in a cluster (e.g., a host cluster and/or a super cluster) to reduce the footprint. In some embodiments, the dynamic light weighted multi-tenancy mechanism may provide transparent service access for a tenant cluster after merging services in a super cluster.

In some embodiments of the present disclosure, the dynamic light weighted multi-tenancy mechanism proposes a new pattern of light-weight multi-tenancy for open source container systems. In some embodiments, the dynamic light weighted multi-tenancy mechanism offers a solution for reducing the footprint and complexity on platforms with duplicative services, including duplicative long-running services.

In some embodiments of the present disclosure, a migration controller may be used to monitor and/or manage resources; managing the resources may include, for example, generating, retrieving, updating, and/or deleting the resources. A migration controller may have logic capabilities to enable the migration controller to monitor and/or manage resources in a cluster (e.g., a super cluster and/or a tenant cluster); in some embodiments, resources may include services in the open source container environment.

In some embodiments of the present disclosure, a migration controller may be used to monitor and/or manage duplicative services in an open source container environment such as a super cluster. A duplicative service is a service with the same customer resource definition (CRD) as another service; for example, when two services have the same CRD, the services are duplicative services because they are the same service. Duplicative services may be in the same super cluster. In some embodiments, duplicative services will not coexist in the same namespace; duplicative services may be in distinct namespaces.

In some embodiments of the present disclosure, the migration controller may enable dynamic light weighted multi-tenancy by combining duplicative services by selecting one duplicative service to serve (e.g., act as a shared service), migrating all dependent services to access the new selected service, and removing the duplicated services. The migration controller may combine the services such that there is only one of a specific type of a service; any dependent services (e.g., clusters needing use of the service) may use the shared service when necessary rather than, for example, an exclusive, individual version thereof.

In some embodiments, a migration controller may watch all tenant clusters assigned to it (e.g., all tenant clusters in a super cluster, or a designated half of the tenant clusters in a super cluster) to check for any duplicated services. The migration controller is an operator and may use logic to monitor the resources including some services. In some embodiments, the migration controller may combine the services such that there are fewer duplications than previously but more than one service. The reduced number of services may be set manually by a user, selected as a default by a system setting, based on the type of service offered, and the like.

In some embodiments, a migration controller may have the capability to adjust the size of the combined service to accommodate for performance concerns. For example, in some embodiments, if additional workloads are expected, the size of the combined service may be increased to improve performance.

In some embodiments, the present disclosure may be used to reduce the footprint of a cluster. Reducing the footprint of a cluster may help to reduce the complexity of the platform. Reducing the footprint of the reduce the heaviness of the cluster such that the cluster requires fewer resources and/or less of a resource draw for one or more workloads. Thus, the present disclosure may enable lightweight use of an open source container environment.

In accordance with some embodiments of the present disclosure, services in host clusters may access each other; for example, one tenant node may use services in another tenant node, and/or super cluster resources may be available to tenant nodes. In some embodiments, the present disclosure may enable one or more dependent services to redirect (e.g., shift) its traffic to other services.

In some embodiments of the present disclosure, a resource request and/or resource limit may be used. For example, one or more services with resource request above a threshold (e.g., 20% or more above a median resource request for the cluster) may be resource limited so as to ensure the combined service has the capacity to serve all dependent services. In some embodiments, a user (e.g., a developer) may identify and manually select one or more services to resource limit based on, for example, an anticipated resource request from the service, the current resource draw on the cluster, a desired resource expenditure schedule, or the like.

In some embodiments, the latest version of the services may be selected as the shared service which may be used to service dependent services. For example, if a cluster has three of the same service with two having a first version and one being an updated version, the shared service may be selected to be the updated version and the first version services may be marked as the duplicative services and dismissed. In some embodiments, an alternative version may be selected as the shared service; for example, a user may have multiple tenant clusters with one having an updated version, the user may prefer a prior version, and the user may manually select the prior version as the shared service and the updated version as the duplicative service.

In some embodiments of the present disclosure, a duplicated service may be any service sharing a CRD with another service; if two CRDs are the same, then the services offer the same service: one of the services may be used as a shared service and the other marked as duplicative.

In some embodiments of the present disclosure, service combination rules may be defined by a user (e.g., a customer, administrator, or developer). The service combination rules may define the rules of how to combine resource requests, resource limits, and the like. In some embodiments, the service combination rules may include identifying which version of a service (e.g., the most updated version, or a particular version) to select as the shared service.

In some embodiments, a migration controller may be based on a virtual cluster solution. The migration controller may be used to watch for any duplicated services for the tenant clusters that may be combined. The duplicated services may be combined to reduce the footprint and the complexity of the system. For example, for IAM services, one system may use one IAM shared amongst different components; all of the IAM services in a system may be combined together to reduce the footprint and complexity of the platform.

In some embodiments, the migration controller may enable an end user to input one or more service combination rules to effectuate different service combinations based on customized rules to reduce footprint. For example, a user may select the service which requests the most resources and limit the shared services that service may obtain from the shared service. For example, a user may select a service requesting the least resources and limit the shared services that service may obtain from the shared service (e.g., to prevent an unexpected resource draw spike). In some embodiments, such service combination rules may be based on, for example, customer requirement and/or user preferences.

In some embodiments, the migration controller may enable requests for different tenant clusters such that resource requests may be re-directed to a shared service only once the shared service is ready to provide service. After all requests have been re-directed to the shared service, all duplicative services may be removed to reduce the footprint of the cluster.

In some embodiments of the present disclosure, the pattern may be leveraged to enable each tenant to have a dedicated virtual cluster with less of a footprint on the overall system. In some embodiments, the present disclosure may enable a hard multi-tenancy with less footprint. In some embodiments, the combination of duplicate services may be made transparent to an end user. In some embodiments, the footprint of the system may be reduced without impacting the workloads of the end user.

Some embodiments of the present disclosure may include a system and/or method for providing a dynamic light-weighted multi-tenancy model for an open source container environment based on a virtual cluster model and a new migration controller to combine duplicated services in super cluster to reduce footprint. In some embodiments, the disclosure may include providing dynamic lightweight multi-tenancy by introducing a migration controller (which may be based on a virtual cluster solution) to a system and using the migration controller to watch for duplicated services for the tenant cluster that may be combined. In some embodiments, the disclosure may include combining, via the migration controller, the duplicated services for each tenant to reduce the footprint and the complexity of the system and enabling, by the migration controller, an end-user to input one or more service combination rules. Service combination rules may identify how a user wants to combine different services based on customized rules to reduce footprint. In some embodiments, the disclosure may include enabling, by the migration controller, requests for different tenant clusters to be re-directed to the shared service only once the shared service is ready to provide service to multiple clusters. In some embodiments, after all requests for different tenant clusters have been re-directed, all duplicative services may be removed. In some embodiments, removing duplicative services from the system may reduce the footprint of the system.

A system in accordance with the present disclosure may include a memory and a processor in communication with the memory. The processor may be configured to perform operations. The operations may include introducing a migration controller to an open-source container environment and assessing the open-source container environment for duplicative services. The operations may include selecting a shared service and a duplicated service from the duplicative services. The operations may include redirecting resource requests through the migration controller to the shared service and terminating the duplicated service.

In some embodiments of the present disclosure, the operations may include scaling the shared service to support the resource requests.

In some embodiments of the present disclosure, the operations may include calculating a duplicative resource usage of the open-source environment while the open-source environment uses the duplicative services. In some embodiments, the operations may include calculating a shared resource usage of the open-source environment while the open-source environment uses the shared service and assessing a resource savings between the duplicative resource usage and the shared resource usage. In some embodiments, the operations may further include engaging the redirecting resource requests because the resource savings achieves a savings threshold.

In some embodiments of the present disclosure, the operations may include enabling an end-user rule input.

In some embodiments of the present disclosure, the operations may include establishing a service combination ruleset for the duplicative services.

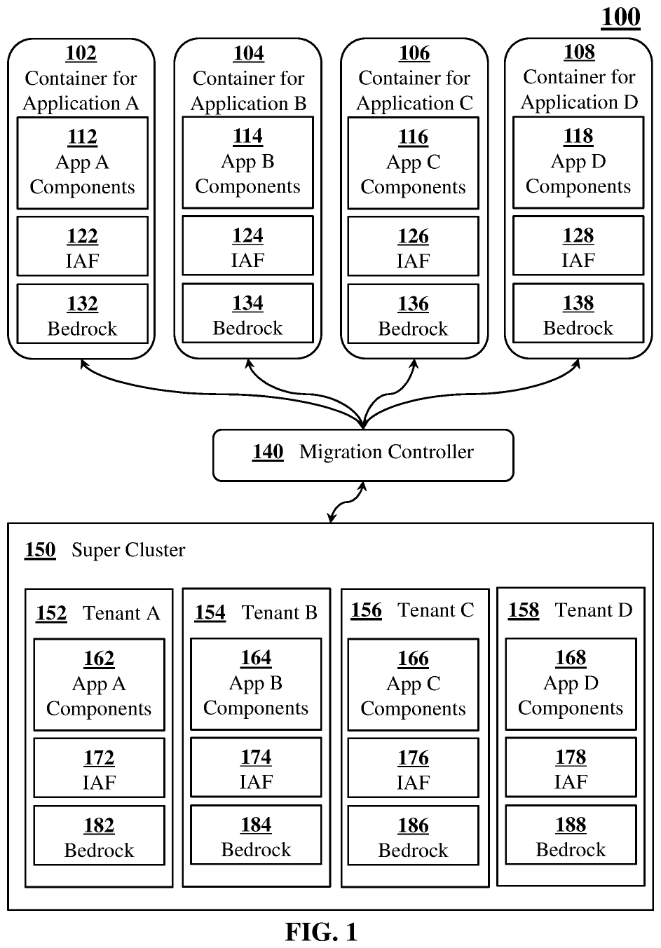

FIG. 1 illustrates the architecture of a system 100 in accordance with some embodiments of the present disclosure. The system 100 includes containers, a migration controller 140, and a super cluster 150.

The system 100 includes a container for application A 102, a container for application B 104, a container for application C 106, and a container for application D 108. Each container has components for its applicable application: the container for application A 102 has application A components 112, the container for application B 104 has application B components 114, the container for application C 106 has application C components 116, and the container for application D 108 has application D components 118. Each container also has IAF services 122, 124, 126, and 128 and bedrock services 132, 134, 136, and 138.

The containers are in communication with a migration controller 140. The migration controller 140 is in communication with a super cluster 150. One or more deployments and/or pods may be running in the super cluster 150. The super cluster 150 has tenant clusters. In some embodiments, each tenant cluster may have one or more CRDs, and each CRD may be defined in its tenant cluster.

The super cluster 150 has four tenant clusters: tenant cluster A 152, tenant cluster B 154, tenant cluster C 156, and tenant cluster D 158. In some embodiments, a host cluster may have more or fewer tenant clusters. Each tenant cluster has components for its applicable application: tenant cluster A 152 has application A components 162, tenant cluster B 154 has application B components 164, tenant cluster C 156 has application C components 166, and tenant cluster D 158 has application D components 168. Each tenant cluster also has IAF services 172, 174, 176, and 178 and bedrock services 182, 184, 186, and 188.

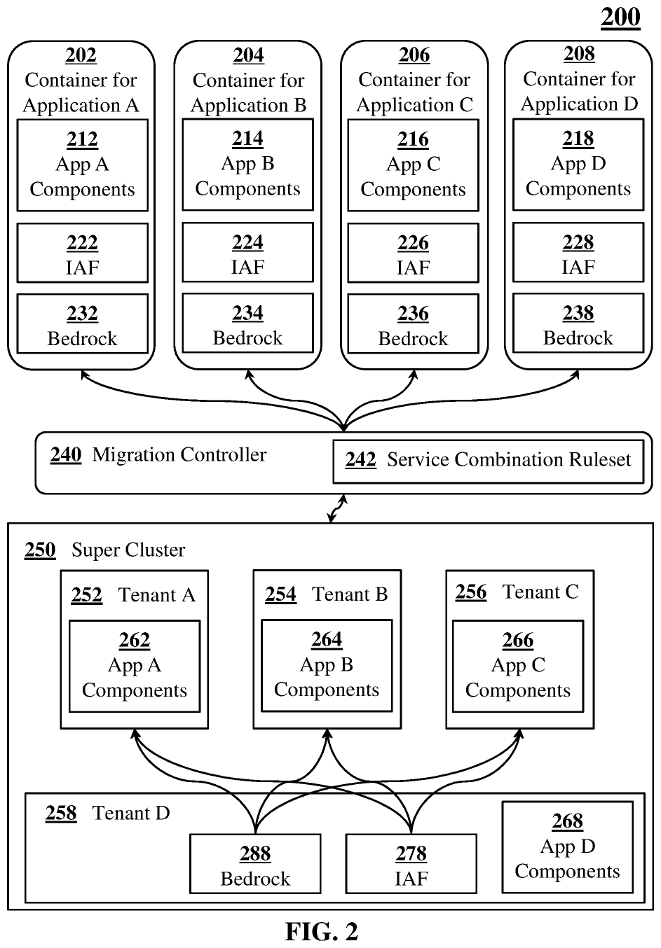

FIG. 2 depicts the architecture of a system 200 in accordance with some embodiments of the present disclosure. The system 200 includes containers, a migration controller 240, and a super cluster 250.

The system 200 includes a container for application A 202, a container for application B 204, a container for application C 206, and a container for application D 208. Each container has components for a specific application: the container for application A 202 has application A components 212, the container for application B 204 has application B components 214, the container for application C 206 has application C components 216, and the container for application D 208 has application D components 218. Each container also has IAF services 222, 224, 226, and 228 and bedrock services 232, 234, 236, and 238.

The containers are in communication with a migration controller 240. The migration controller 240 includes a service combination ruleset 242. In some embodiments of the present disclosure, the service combination ruleset 242 may have been set automatically based on, for example, presents and/or one or more predetermined thresholds; in some embodiments, the service combination ruleset 242 may have been manually set by a user, for example, an end user, developer, or administrator. The migration controller 240 is in communication with a super cluster 250. Deployments and/or pods may be running in the super cluster 250. The super cluster 250 has tenant clusters.

The super cluster 250 has four tenant clusters: tenant cluster A 252, tenant cluster B 254, tenant cluster C 256, and tenant cluster D 258. In some embodiments, a host cluster may have more or fewer tenant clusters. Each tenant cluster has components for a distinct application: tenant cluster A 252 has application A components 262, tenant cluster B 254 has application B components 264, tenant cluster C 256 has application C components 266, and tenant cluster D 258 has application D components 268.

Tenant cluster D 258 hosts shared services and shares the shared services with the other tenant clusters. Specifically, tenant cluster D 258 has shared IAF services 278 and shared bedrock services 288. Tenant cluster D 258 shares the shared services with the other tenant clusters such that when a tenant cluster in the super cluster 250 requests use of IAF and/or bedrock services, tenant D shares the IAF services 278 and/or the bedrock services 288 in accordance with the service combination ruleset 242.

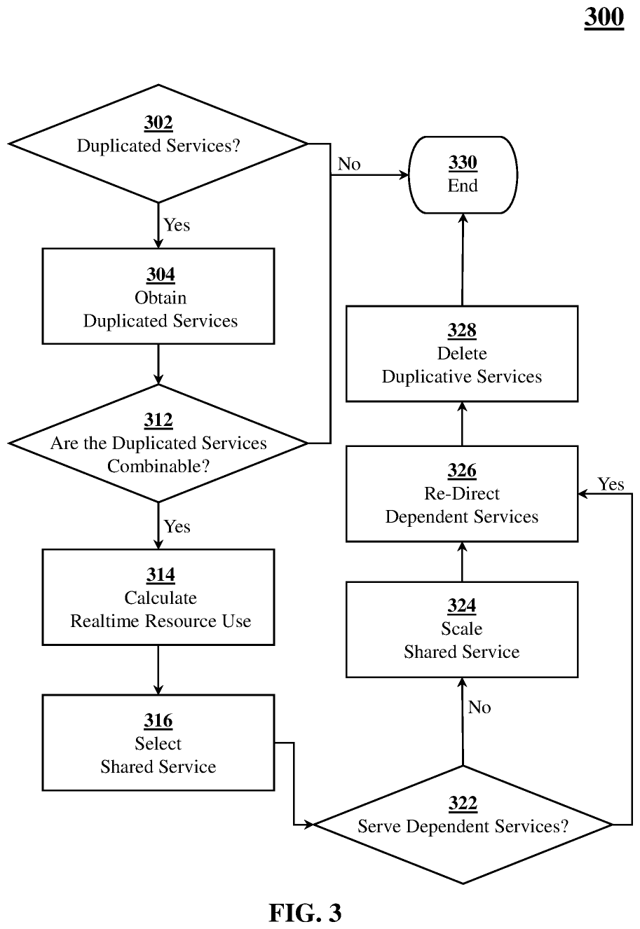

FIG. 3 illustrates a service combination flowchart 300 in accordance with some embodiments of the present disclosure. The service combination flowchart 300 starts by identifying 302 whether or not there are duplicated services within the same host environment; if there are no duplicated services, the process ends 330. If there are duplicated services, then the service combination flowchart 300 continues by obtaining 304 the duplicated services and determining 312 whether the duplicated services are combinable. If the duplicated services are not combinable, the process ends 330.

If the duplicated services are combinable, the service combination flowchart 300 continues by calculating 314 the real time resource usage of the services. The calculation may include, for example, the resource usage of all of the duplicated services, the resource usage of an anticipated shared resource usage if a shared service model were implemented, a resource savings expectation from implementing a shared service model, whether implementing a shared service model would achieve a shared resources threshold, and/or the like.

The service combination flowchart 300 continues by selecting 316 a shared service. The shared service may be selected from duplicated services (e.g., by marking one of the duplicated services in a super cluster as the shared service and other duplicated services as the duplicative services) based on policies (e.g., whether a service has the most resources of the duplicated services) and/or according to a service combination ruleset (e.g., service combination ruleset 242 of system 200 in FIG. 2).

The service combination flowchart 300 continues by checking 322 whether the shared service has enough resources to serve all of the pending dependent services (e.g., its host tenant cluster and all duplicative services, also referred to the services in the tenant clusters in the system which the shared service will be servicing). If the shared service does not have the resources necessary to support the pending dependent services, the process continues by scaling 324 the shared services to be able to support the pending dependent services; if the shared service already has enough resources to support the pending dependent services, scaling 324 the shared services may be omitted as the shared service is already able to support the pending dependent services.

The service combination flowchart 300 continues by re-directing 326 service requests for the pending dependent services to the shared service. In some embodiments, re-directing 326 the service requests may be done by a migration controller (e.g., the migration controller 140 of FIG. 1) and/or done in accordance with user-set rules (e.g., via a service combination ruleset 242 as shown in FIG. 2). Redirecting 326 the service requests to the shared service may result in a greater resource draw on the shared service and the elimination of pulling resources from any of the duplicative services.

The service combination flowchart 300 continues by deleting 328 the duplicative services, that is, deleting any service requests which are now serviced by the shared service. For example, referring to FIG. 1, if the bedrock services 188 in tenant D 158 were selected as the shared service and the bedrock services 182 in tenant A 152 were duplicative of the bedrock services 188 in tenant D 158, then the service requests for the bedrock services 182 in tenant A 152 would be redirected to the bedrock services 188 in tenant D 158 and then the bedrock services 182 in tenant A 152 would be deleted.

After deleting 328 the duplicative services, the service combination flowchart 300 ends 330.

A computer-implemented method in accordance with the present disclosure may include introducing a migration controller to an open-source container environment and assessing the open-source container environment for duplicative services. The method may include selecting a shared service and a duplicated service from the duplicative services. The method may include redirecting resource requests through the migration controller to the shared service and terminating the duplicated service.

In some embodiments of the present disclosure, the method may include scaling the shared service to support the resource requests.

In some embodiments of the present disclosure, the method may include calculating a duplicative resource usage of the open-source environment while the open-source environment uses the duplicative services. In some embodiments, the method may include calculating a shared resource usage of the open-source environment while the open-source environment uses the shared service and assessing a resource savings between the duplicative resource usage and the shared resource usage. In some embodiments, the method may further include engaging the redirecting resource requests because the resource savings achieves a savings threshold.

In some embodiments of the present disclosure, the method may include enabling an end-user rule input.

In some embodiments of the present disclosure, the method may include establishing a service combination ruleset for the duplicative services.

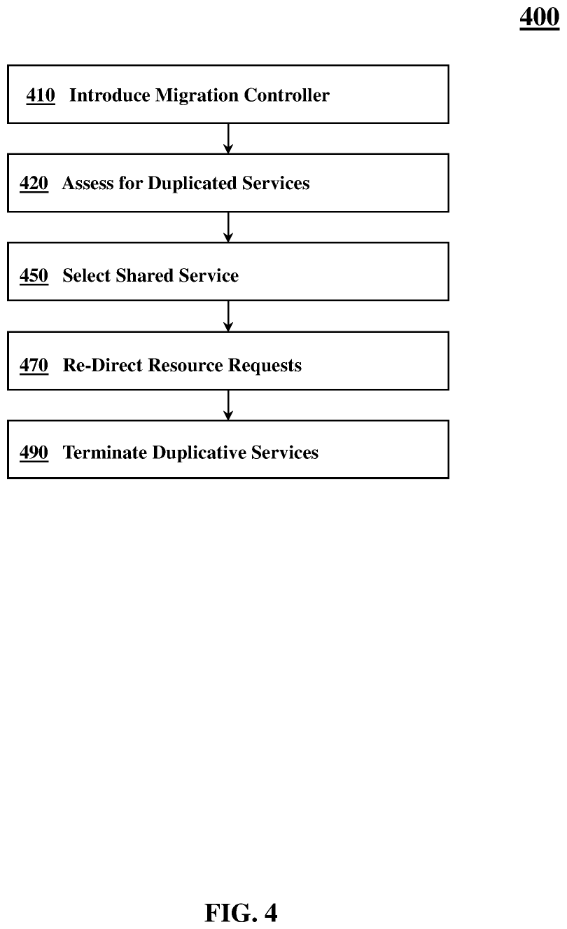

FIG. 4 depicts a computer-implemented method 400 in accordance with some embodiments of the present disclosure. The method 400 may be implemented by a distributed workload system such as, for example, system 100 of FIG. 1.

The method 400 includes introducing 410 a migration controller (e.g., migration controller 140 of FIG. 1) to a system and assessing 420 the system for duplicated services. The migration controller may be used to assess for duplicated services. In some embodiments, assessing 420 the system for duplicated services may include, for example, identifying duplicated services (e.g., identifying 302 there are duplicated services in a host environment per FIG. 3) in a system, obtaining the services (e.g., obtaining 304 the duplicated services per FIG. 3), and/or determining the compatibility of the duplicated services (e.g., determining 312 whether the duplicated services are combinable per FIG. 3).

The method 400 includes selecting 450 a shared service (e.g., selecting 316 according to FIG. 3). The shared service may be selected from duplicated services based on policies and/or according to a service combination ruleset. In some embodiments, a new service may be implemented in the host cluster specifically for the purpose of being the shared service.

The method 400 includes re-directing 470 resource requests to the shared service (e.g., re-directing 326 service requests for the pending dependent services to the shared service according to FIG. 3). In some embodiments, re-directing 470 the resource requests may be done by a migration controller (e.g., the migration controller 140 of FIG. 1) and/or done in accordance with user-set rules (e.g., via a service combination ruleset 242 as shown in FIG. 2).

The method 400 includes terminating 490 duplicative services (e.g., deleting 328 the duplicative services per FIG. 3). For example, referring to FIG. 1, if the bedrock services 188 in tenant D 158 were selected as the shared service and the bedrock services 182 in tenant A 152 were duplicative of the bedrock services 188 in tenant D 158, then the service requests for the bedrock services 182 in tenant A 152 would be redirected to the bedrock services 188 in tenant D 158 and then the bedrock services 182 in tenant A 152 would be terminated.

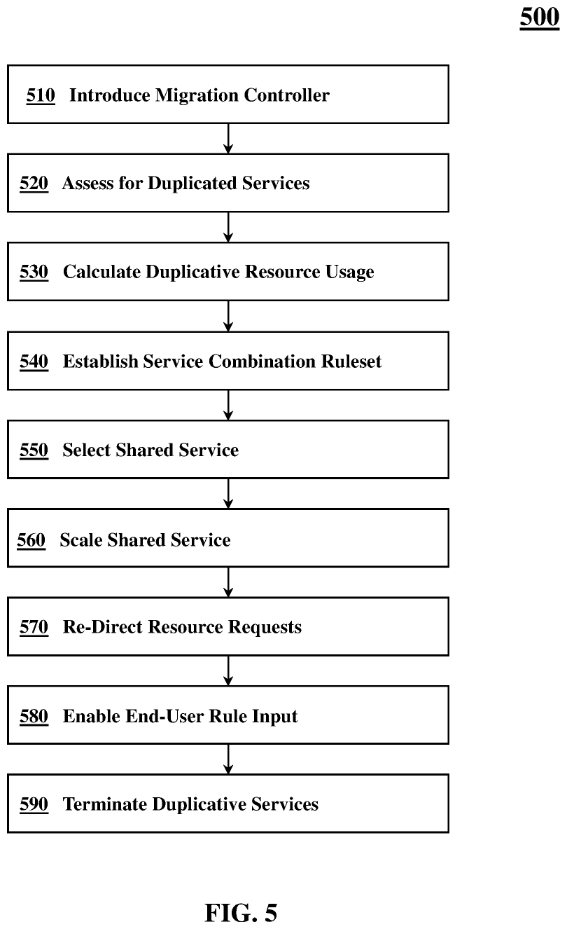

FIG. 5 illustrates computer-implemented method 500 in accordance with some embodiments of the present disclosure. The method 500 includes introducing 510 a migration controller to a system and assessing 520 the system for duplicated services.

The method 500 includes calculating 530 duplicative resource usage (e.g., calculating 314 the real time resource usage of the services per FIG. 3). Such a calculation may include, for example, the resource usage of all of the duplicated services, the resource usage of an anticipated shared resource usage if a shared service model were implemented, a resource savings expectation from implementing a shared service model, whether implementing a shared service model would achieve a shared resources threshold, and/or the like.

The method 500 includes establishing 540 a service combination ruleset (e.g., service combination ruleset 242 of system 200 in FIG. 2). The service combination ruleset may be established automatically (e.g., via an algorithm given parameters and/or thresholds to establish the ruleset) or manually (e.g., via an administrator or end user designating one or more rules for the service combination ruleset).

The method 500 includes selecting 550 a shared service (e.g., selecting 316 according to FIG. 3). The shared service may be selected from duplicated services based on policies and/or according to a service combination ruleset. In some embodiments, a new service may be implemented in the host cluster specifically for the purpose of being the shared service.

The method 500 includes scaling 560 the shared service (e.g., scaling 324 the shared services to be able to support the pending dependent services per FIG. 3).

The method 500 includes re-directing 570 resource requests to the shared service (e.g., re-directing 326 service requests for the pending dependent services to the shared service according to FIG. 3). In some embodiments, re-directing 470 the resource requests may be done by a migration controller (e.g., the migration controller 140 of FIG. 1) and/or done in accordance with user-set rules (e.g., via a service combination ruleset 242 as shown in FIG. 2).

The method 500 includes enabling 580 end-user rule input. In some embodiments, a migration controller may be used for enabling 580 an end user to input one or more service combination rules to effectuate different service combinations based on customized rules to reduce footprint. For example, a user may select a service to limit the draw from the shared services of that service from the shared service. In some embodiments, an end user may input service combination rules (e.g., the service combination rules 242 of FIG. 2); service combination rules may be based on, for example, customer requirement and/or user preferences.

The method 500 includes terminating 590 duplicative services (e.g., deleting 328 the duplicative services per FIG. 3). For example, referring to FIG. 1, if the bedrock services 188 in tenant D 158 were selected as the shared service and the bedrock services 182 in tenant A 152 were duplicative of the bedrock services 188 in tenant D 158, then the service requests for the bedrock services 182 in tenant A 152 would be redirected to the bedrock services 188 in tenant D 158 and then the bedrock services 182 in tenant A 152 would be terminated.

A computer program product in accordance with the present disclosure may include a computer readable storage medium having program instructions embodied therewith. The program instructions may be executable by a processor to cause the processor to perform a function. The function may include introducing a migration controller to an open-source container environment and assessing the open-source container environment for duplicative services. The function may include selecting a shared service and a duplicated service from the duplicative services. The function may include redirecting resource requests through the migration controller to the shared service and terminating the duplicated service.

In some embodiments of the present disclosure, the function may include scaling the shared service to support the resource requests.

In some embodiments of the present disclosure, the function may include calculating a duplicative resource usage of the open-source environment while the open-source environment uses the duplicative services. In some embodiments, the function may include calculating a shared resource usage of the open-source environment while the open-source environment uses the shared service and assessing a resource savings between the duplicative resource usage and the shared resource usage. In some embodiments, the function may further include engaging the redirecting resource requests because the resource savings achieves a savings threshold.

In some embodiments of the present disclosure, the function may include enabling an end-user rule input.

In some embodiments of the present disclosure, the function may include establishing a service combination ruleset for the duplicative services.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment currently known or that which may be later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model with different physical and virtual resources dynamically assigned and reassigned according to demand. There is a sense of portion independence in that the consumer generally has no control or knowledge over the exact portion of the provided resources but may be able to specify portion at a higher level of abstraction (e.g., country, state, or datacenter).

Rapid elasticity: capabilities can be rapidly and elastically provisioned, in some cases automatically, to quickly scale out and rapidly release to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but the consumer has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software which may include operating systems and applications. The consumer does not manage or control the underlying cloud infrastructure but has control over operating systems, storage, and deployed applications, and the consumer possibly has limited control of select networking components (e.g., host firewalls).

Deployment models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and/or compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

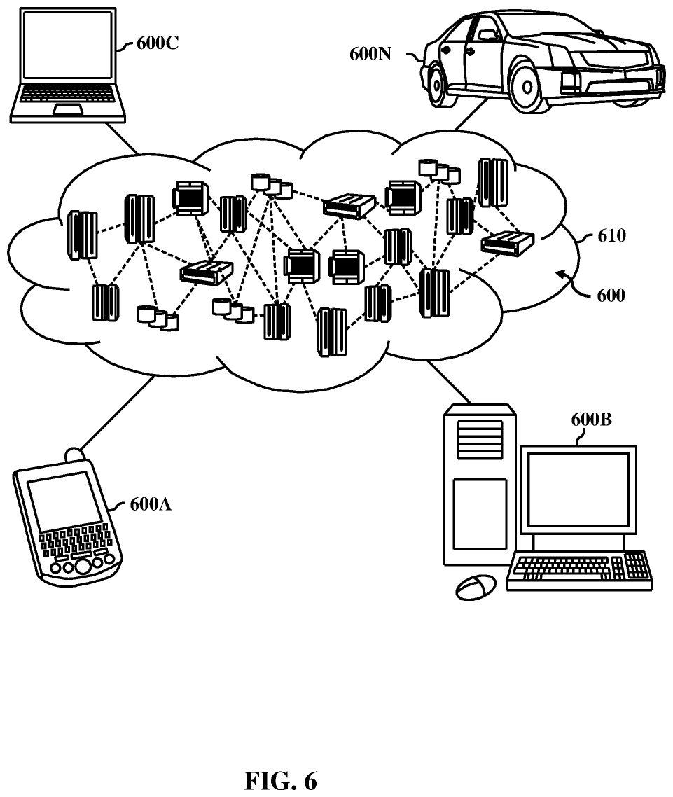

FIG. 6 illustrates a cloud computing environment 610 in accordance with embodiments of the present disclosure. As shown, cloud computing environment 610 includes one or more cloud computing nodes 600 with which local computing devices used by cloud consumers such as, for example, personal digital assistant (PDA) or cellular telephone 600A, desktop computer 600B, laptop computer 600C, and/or automobile computer system 600N may communicate. Nodes 600 may communicate with one another. They may be grouped (not shown) physically or virtually, in one or more networks, such as private, community, public, or hybrid clouds as described hereinabove, or a combination thereof.

This allows cloud computing environment 610 to offer infrastructure, platforms, and/or software as services for which a cloud consumer does not need to maintain resources on a local computing device. It is understood that the types of computing devices 600A-N shown in FIG. 6 are intended to be illustrative only and that computing nodes 600 and cloud computing environment 610 can communicate with any type of computerized device over any type of network and/or network addressable connection (e.g., using a web browser).

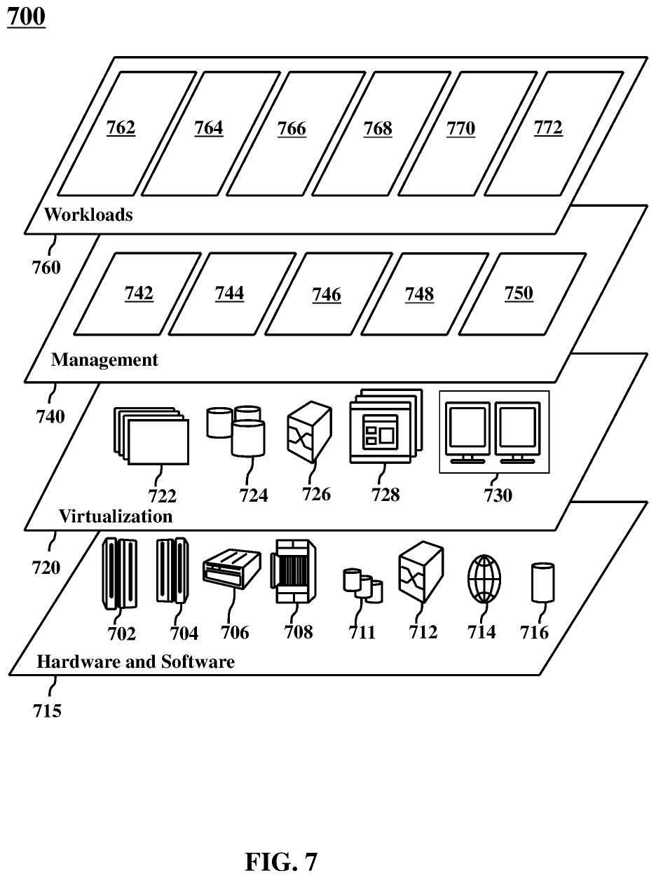

FIG. 7 illustrates abstraction model layers 700 provided by cloud computing environment 610 (FIG. 6) in accordance with embodiments of the present disclosure. It should be understood in advance that the components, layers, and functions shown in FIG. 7 are intended to be illustrative only and embodiments of the disclosure are not limited thereto. As depicted below, the following layers and corresponding functions are provided.

Hardware and software layer 715 includes hardware and software components. Examples of hardware components include: mainframes 702; RISC (Reduced Instruction Set Computer) architecture-based servers 704; servers 706; blade servers 708; storage devices 711; and networks and networking components 712. In some embodiments, software components include network application server software 714 and database software 716.

Virtualization layer 720 provides an abstraction layer from which the following examples of virtual entities may be provided: virtual servers 722; virtual storage 724; virtual networks 726, including virtual private networks; virtual applications and operating systems 728; and virtual clients 730.

In one example, management layer 740 may provide the functions described below. Resource provisioning 742 provides dynamic procurement of computing resources and other resources that are utilized to perform tasks within the cloud computing environment. Metering and pricing 744 provide cost tracking as resources and are utilized within the cloud computing environment as well as billing or invoicing for consumption of these resources. In one example, these resources may include application software licenses. Security provides identity verification for cloud consumers and tasks as well as protection for data and other resources. User portal 746 provides access to the cloud computing environment for consumers and system administrators. Service level management 748 provides cloud computing resource allocation and management such that required service levels are met. Service level agreement (SLA) planning and fulfillment 750 provide pre-arrangement for, and procurement of, cloud computing resources for which a future requirement is anticipated in accordance with an SLA.

Workloads layer 760 provides examples of functionality for which the cloud computing environment may be utilized. Examples of workloads and functions which may be provided from this layer include: mapping and navigation 762; software development and lifecycle management 764; virtual classroom education delivery 766; data analytics processing 768; transaction processing 770; and dynamic light weighted multi-tenancy 772.

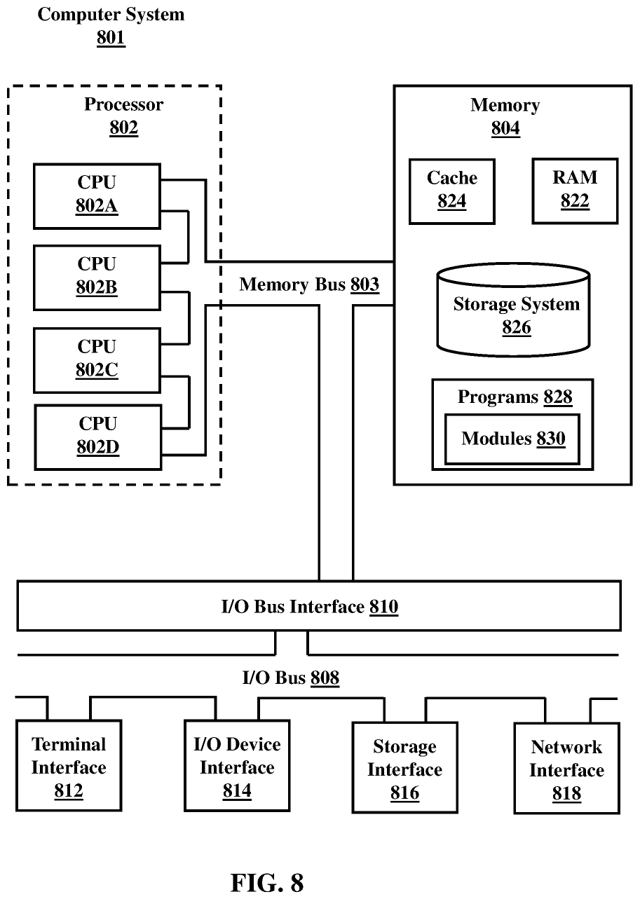

FIG. 8 illustrates a high-level block diagram of an example computer system 801 that may be used in implementing one or more of the methods, tools, and modules, and any related functions, described herein (e.g., using one or more processor circuits or computer processors of the computer) in accordance with embodiments of the present disclosure. In some embodiments, the major components of the computer system 801 may comprise a processor 802 with one or more central processing units (CPUs) 802A, 802B, 802C, and 802D, a memory subsystem 804, a terminal interface 812, a storage interface 816, an I/O (Input/Output) device interface 814, and a network interface 818, all of which may be communicatively coupled, directly or indirectly, for inter-component communication via a memory bus 803, an I/O bus 808, and an I/O bus interface unit 810.

The computer system 801 may contain one or more general-purpose programmable CPUs 802A, 802B, 802C, and 802D, herein generically referred to as the CPU 802. In some embodiments, the computer system 801 may contain multiple processors typical of a relatively large system; however, in other embodiments, the computer system 801 may alternatively be a single CPU system. Each CPU 802 may execute instructions stored in the memory subsystem 804 and may include one or more levels of on-board cache.

System memory 804 may include computer system readable media in the form of volatile memory, such as random access memory (RAM) 822 or cache memory 824. Computer system 801 may further include other removable/non-removable, volatile/non-volatile computer system storage media. By way of example only, storage system 826 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM, or other optical media can be provided. In addition, memory 804 can include flash memory, e.g., a flash memory stick drive or a flash drive. Memory devices can be connected to memory bus 803 by one or more data media interfaces. The memory 804 may include at least one program product having a set (e.g., at least one) of program modules that are configured to carry out the functions of various embodiments.

One or more programs/utilities 828, each having at least one set of program modules 830, may be stored in memory 804. The programs/utilities 828 may include a hypervisor (also referred to as a virtual machine monitor), one or more operating systems, one or more application programs, other program modules, and program data. Each of the operating systems, one or more application programs, other program modules, and program data, or some combination thereof, may include an implementation of a networking environment. Programs 828 and/or program modules 830 generally perform the functions or methodologies of various embodiments.

Although the memory bus 803 is shown in FIG. 8 as a single bus structure providing a direct communication path among the CPUs 802, the memory subsystem 804, and the I/O bus interface 810, the memory bus 803 may, in some embodiments, include multiple different buses or communication paths, which may be arranged in any of various forms, such as point-to-point links in hierarchical, star, or web configurations, multiple hierarchical buses, parallel and redundant paths, or any other appropriate type of configuration. Furthermore, while the I/O bus interface 810 and the I/O bus 808 are shown as single respective units, the computer system 801 may, in some embodiments, contain multiple I/O bus interface units 810, multiple I/O buses 808, or both. Further, while multiple I/O interface units 810 are shown, which separate the I/O bus 808 from various communications paths running to the various I/O devices, in other embodiments some or all of the I/O devices may be connected directly to one or more system I/O buses 808.

In some embodiments, the computer system 801 may be a multi-user mainframe computer system, a single-user system, a server computer, or similar device that has little or no direct user interface but receives requests from other computer systems (clients). Further, in some embodiments, the computer system 801 may be implemented as a desktop computer, portable computer, laptop or notebook computer, tablet computer, pocket computer, telephone, smartphone, network switches or routers, or any other appropriate type of electronic device.

It is noted that FIG. 8 is intended to depict the representative major components of an exemplary computer system 801. In some embodiments, however, individual components may have greater or lesser complexity than as represented in FIG. 8, components other than or in addition to those shown in FIG. 8 may be present, and the number, type, and configuration of such components may vary.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide, or other transmission media (e.g., light pulses passing through a fiber-optic cable) or electrical signals transmitted through a wire.

Computer readable program instructions described herein can be downloaded to respective computing/processing devices from a computer readable storage medium or to an external computer or external storage device via a network, for example, the Internet, a local area network, a wide area network, and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer, or entirely on a remote computer or server. In the latter scenario, the remote computer may be connected to the user's computer through any type of network, including a local area network (LAN) or a wide area network (WAN) or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions which comprises one or more executable instructions for implementing the specified logical function(s). In some alternative implementations, the functions noted in the blocks may occur out of the order noted in the figures. For example, two blocks shown in succession may, in fact, be accomplished as one step, executed concurrently, substantially concurrently, in a partially or wholly temporally overlapping manner, or the blocks may sometimes be executed in the reverse order depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although the present disclosure has been described in terms of specific embodiments, it is anticipated that alterations and modifications thereof will become apparent to the skilled in the art. The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application, or the technical improvement over technologies found in the marketplace or to enable others of ordinary skill in the art to understand the embodiments disclosed herein. Therefore, it is intended that the following claims be interpreted as covering all such alterations and modifications as fall within the true spirit and scope of the disclosure.

What is claimed is:

1. A system, said system comprising:
a memory; and
a processor in communication with said memory, said processor being configured to perform operations, said operations comprising:
introducing a migration controller to an open-source container environment;
assessing said open-source container environment for duplicative services;
selecting a shared service and a duplicated service from said duplicative services;
redirecting resource requests through said migration controller to said shared service; and
terminating said duplicated service.

2. The system of claim 1, said operations further comprising:
scaling said shared service to support said resource requests.

3. The system of claim 1, said operations further comprising:
calculating a duplicative resource usage of said open-source environment while said open-source environment uses said duplicative services.

4. The system of claim 3, said operations further comprising:
calculating a shared resource usage of said open-source environment while said open-source environment uses said shared service; and
assessing a resource savings between said duplicative resource usage and said shared resource usage.

5. The system of claim 4, said operations further comprising:
engaging said redirecting resource requests because said resource savings achieves a savings threshold.

6. The system of claim 1, said operations further comprising:
enabling an end-user rule input.

7. The system of claim 1, said operations further comprising:
establishing a service combination ruleset for said duplicative services.

8. A computer-implemented method, said method comprising:
introducing a migration controller to an open-source container environment;
assessing said open-source container environment for duplicative services;
selecting a shared service and a duplicated service from said duplicative services;
redirecting resource requests through said migration controller to said shared service; and
terminating said duplicated service.

9. The computer-implemented method of claim 8, further comprising:
scaling said shared service to support said resource requests.

10. The computer-implemented method of claim 8, further comprising:
calculating a duplicative resource usage of said open-source environment while said open-source environment uses said duplicative services.

11. The computer-implemented method of claim 10, further comprising:
calculating a shared resource usage of said open-source environment while said open-source environment uses said shared service; and
assessing a resource savings between said duplicative resource usage and said shared resource usage.

12. The computer-implemented method of claim 11, further comprising:
engaging said redirecting resource requests because said resource savings achieves a savings threshold.

13. The computer-implemented method of claim 8, further comprising:
enabling an end-user rule input.

14. The computer-implemented method of claim 8, further comprising:
establishing a service combination ruleset for said duplicative services.

15. A computer program product, said computer program product comprising a computer readable storage medium having program instructions embodied therewith, said program instructions executable by a processor to cause said processor to perform a function, said function comprising:
introducing a migration controller to an open-source container environment;
assessing said open-source container environment for duplicative services;
selecting a shared service and a duplicated service from said duplicative services;
redirecting resource requests through said migration controller to said shared service; and
terminating said duplicated service.

16. The computer program product of claim 15, said function further comprising:
scaling said shared service to support said resource requests.

17. The computer program product of claim 15, said function further comprising:
calculating a duplicative resource usage of said open-source environment while said open-source environment uses said duplicative services.

18. The computer program product of claim 17, said function further comprising:
calculating a shared resource usage of said open-source environment while said open-source environment uses said shared service;
assessing a resource savings between said duplicative resource usage and said shared resource usage; and
engaging said redirecting resource requests because said resource savings achieves a savings threshold.

19. The computer program product of claim 15, said function further comprising:
enabling an end-user rule input.

20. The computer program product of claim 15, said function further comprising:
establishing a service combination ruleset for said duplicative services.
